(19) United States
(12) Patent Application Publication
(10) Pub. No.: US 2009/0016801 A1
(43) Pub. Date: Jan. 15, 2009

(54) Handy tool pen

(75) Inventor: Yu-Yin Liu, Taipei (TW)

Correspondence Address: Zuei-Ho Liu of Spark Gold Co., P.O.Box 10-123, Dei-Hu Dist., Taipei, 11449, TW

(73) Assignee: Spark Gold Co.

(21) Appl. No.: 11/822,553

(22) Filed: Jul. 9, 2007

(51) Int. Cl. B43K 5/16; B43K 29/00; B26B 11/00

(52) U.S. Cl. 401/116; 401/195; 7/160; 7/165

(57) ABSTRACT

A handy tool pen is mainly constituted, for example, to write a brief summary and to implement a repair of hardware equipment. A hollow shaft 20 has a working end at a proximal end, where a hole axially formed through a center. A handwriting instrument of the refills is thereby stretched out from the working end, or retracted in the working end. When the handwriting instrument stretched out from the hole can write well, while the handwriting instrument retracted in the working end, which can implement a repair for hardware equipment. As well known, a spring fit around a circular cylindrical surface of the refills can urge the refills descend downward to stretch out the handwriting instrument to write, and also can urge the refills elevate upward to retract in the working end, which use for repairing office equipment or even hardware.

### FIELD OF THE INVENTION

The present invention relates to a pen with handwriting instrument which can be stretched out flat tip or philips tip for repairing, or retracting back them for handwriting.

### DESCRIPTION ABOUT PRIOR ARTS

Handwriting instrument incorporated into handy tool set is already popular on the markets, such as multi-tool pen, handy tool/laser pointer pen, handy tool/UV pen are familiarity to customers. However, hand-written texts are still widely accepted, person skilled in the art have provided various assemblages of handy tool pen for customers' references. The multi-tool pen can be selectively provided with working ends stretch to thirteen or five tools in a set; such as flat/philips tips, ball point pin, pair of tweezers, knives and blades. They are included in one set.

For example, U.S. Pat. No. 4,519,152 entitled “tamper proof poster display device” to Steely et al. on May 28, 1995, it was mentioned about a frame can be pried open with any handy tool, such as a pen or a knife. Usually, the pen is not restricted to a handwriting instrument, but a tool used as a lever arm to pry a box open. However, ink may leak ones' dress, and the handwriting instrument is out of shape.

In U.S. Pat. No. 6,922,870 entitled “torque magnifying handle for driving tool” to Tontz Sr. et al. on Aug. 2, 2005, it disclosed that philips tip, flat tip, socket, or fastening means may be assembled to a lower end of a blade, which can be inserted into longitudinal or transverse bores of a handle. When needed, even in operation it can be implemented more torque with less fatigue on the surgeon's hand. However, it did not mention a handwriting instrument may be assembled to the blade.

In U.S. Pat. No. 6,783,295 entitled “applicator” to Masahiro Yasunga on Aug. 31, 2004, it depicted that a cylinder body filled with ink for application. So called “twin-type” applicator that has two pen points on both end of the cylindrical body, where two detachable distal plugs are provided on the “twin-type” applicator as shown in FIGS. 20-21. However, neither proximal nor distal plug assembled to the body has ever been equipped with a working end.

In U.S. Pat. No. 6,874,188 entitled “Multi-tasking utility tool” to Ronal L. Johnson et al. on Apr. 5, 2005, it taught that a rotating cartridge unit having highlighting marker and pen covered by caps is incorporated into a body coupled with a knife compartment, a pin maintain a friction fit between the body and the knife compartment, which rotates about the pin when moving between open and closed position. Knife compartment can also couple to the body by a snap fit, screws, etc. However, both cartridge and compartment are substantially two rotating fixtures. In consideration of an ergonomic two part tool, individually, either cartridge or compartment, in appliance, can be implemented as a sole tool, but in group, a dual working end and handwriting instrument configuration is not developed in U.S. Pat. No. 6,874,188 to reduce bulky volume of the cartridge and the compartment.

### SUMMARY OF THE INVENTION

Accordingly, a primary object of the present invention is to provide a handy tool pen, both handwriting instrument and working end can be exchanged promptly.

Another object of the invention is to provide a handy tool pen. Their both ends of the pen can be equipped with working ends.

Point against aforesaid problems, the present invention is to provide a handy tool pen 10 characterized in that: a proximal end of a hollow shaft 20 is equipped with a working end 21; a hole 22 is axially formed through the working end 21 at a center, a handwriting instrument 31 of a refills 30 can be alternatively stretched out from the hole 22, or retracted in the hole 22.

A handy tool pen as mentioned above, wherein a polygonal ring 23 is installed to a distal end of the working end 21, the polygonal ring 23 fits in a polygonal groove 261 at a proximal end of the hollow shaft 20.

A handy tool pen as mentioned above, wherein a distal end of the hollow shaft 20 has a fixed portion 40 resists against a distal end of the refills 30.

A handy tool pen as mentioned above, wherein a polygonal nut 24 embedded in a polygonal groove 262, which is at a distal end of the hollow shaft 20, the fixed portion 40 has a screw bolt 41 screwed to an inner hole 25 of the nut 24, whereby the screw bolt 41 can be adjusted to and fro.

A handy tool pen as mentioned above, wherein an expansion spring 32 fit around a circular cylindrical surface of the refills 30, a distal end of the refills 30 has a stopper 33 to resist against the expansion spring 32.

A handy tool pen as mentioned above, wherein a distal end of the screw bolt 41 of the fixed portion 40 has a polygonal connector 42, while a proximal end of the screw bolt 41 has a working end 43, the polygonal connector 42 fits in the polygonal groove 262.

A handy tool pen as mentioned above, wherein a circumference of the polygonal connector 42 is formed with a shallow groove for embedding an annular rubber ring 45 therein.

A handy tool pen as mentioned above, wherein the working end 21 can be selected from one of the following: philips tip, flat tip, hexangular socket head nut.

A handy tool pen as mentioned above, wherein the working end 21 of the fixed portion 40 can be selected from one of the following: philips tip, cross like tip, hexangular socket head nut, drill head, awl.

### BRIEF DESCRIPTION OF DRAWINGS OF THE INVENTION

FIG. 1: shows a perspective view of a first embodiment of the handy tool pen of the invention;

FIG. 2: shows a cross sectional view of FIG. 1;

FIG. 3: shows a cross sectional view of FIG. 2, after a refills is taken out;

FIG. 4: shows an exploded view of a second embodiment of the invention;

FIG. 5: shows a cross-sectional view of FIG. 4 as a handwriting instrument retracted in a working end;

FIG. 6: shows a cross-sectional view of FIG. 4 as the handwriting instrument stretched out from the working end;

FIG. 7: shows a perspective view of FIG. 4, both ends of a hollow shaft are equipped with working ends;

FIG. 8: shows a cross-sectional view of FIG. 7;

FIG. 9: shows a perspective view of a third embodiment of the invention in part, where the handwriting instrument retracted in the working end;

FIG. 10: shows a cross-sectional view of FIG. 9, but the handwriting instrument stretched out from the working end;

FIG. 11: shows a schematic view of the handy tool pen used with its handwriting instrument at the proximal end; and

FIGS. 12˜13: shows schematic views of the handy tool pen, both ends of the pen are equipped with working ends.

### DETAILED DESCRIPTION OF THE PREFERRED EMBODIMENTS OF THE INVENTION

Detailed description is describing the detail which accords to the appended drawings hereinafter.

### First Embodiment

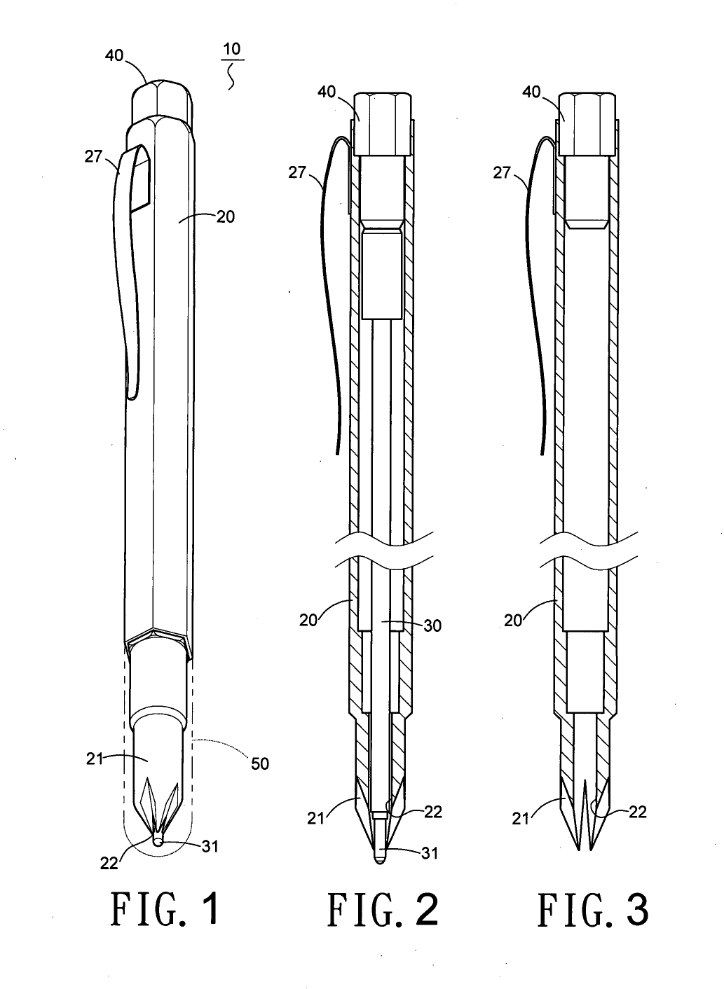

As shown in FIGS. 1˜3, a handy tool pen 10 includes a hollow shaft 20, a refills 30 fit through the hollow shaft 20, a working end 21 combined to a proximal end of the hollow shaft 20, and a fixed portion 40 combined to a distal end of the hollow shaft, a proximal end of the fixed portion 40 resists against a distal end of the refills 30. The handy tool 21 has a hole 22 axially formed through the working end 21 at a center 22 thereof; thereby a handwriting instrument 31 of the refills 30 can be guided to stretch out from the working end 21 to facilitate a handwriting for a customers. When the refill 30 is taken out from the hollow shaft 20, the working end 21 can be used to tighten or loosen screws. (not shown)

As mentioned above, the working end 21 is formed as being equipped with a Philips tip; the hole 22 is located at the center 22 of the Philips tip 21, where the handwriting instrument 31 of the refills 30 can be stretched out or retracted in the Philips tip 21. As an example of prior arts, to retract the refills, slide a slide button (not shown) down and push it to retract. A spring mechanism will automatically retract the refills. Conversely, when the slide button is released from prior sliding down position, the spring mechanism will automatically stretch the refills. More details of the spring 32 will be described in the second embodiment.

Furthermore, the hollow shaft 20 is integrally formed with the working end (namely, Philips tip) 21 as a whole. While the fixed portion 40 fits in a distal end of the hollow shaft 20, outside of the hollow shaft 20, a clip 27 added to the hollow shaft to facilitate either a clamp or a hitch about a pocket. In addition, the working end 21 can be received inside a cap 50 designed to protect the working end 21 which is not in use.

### Second Embodiment

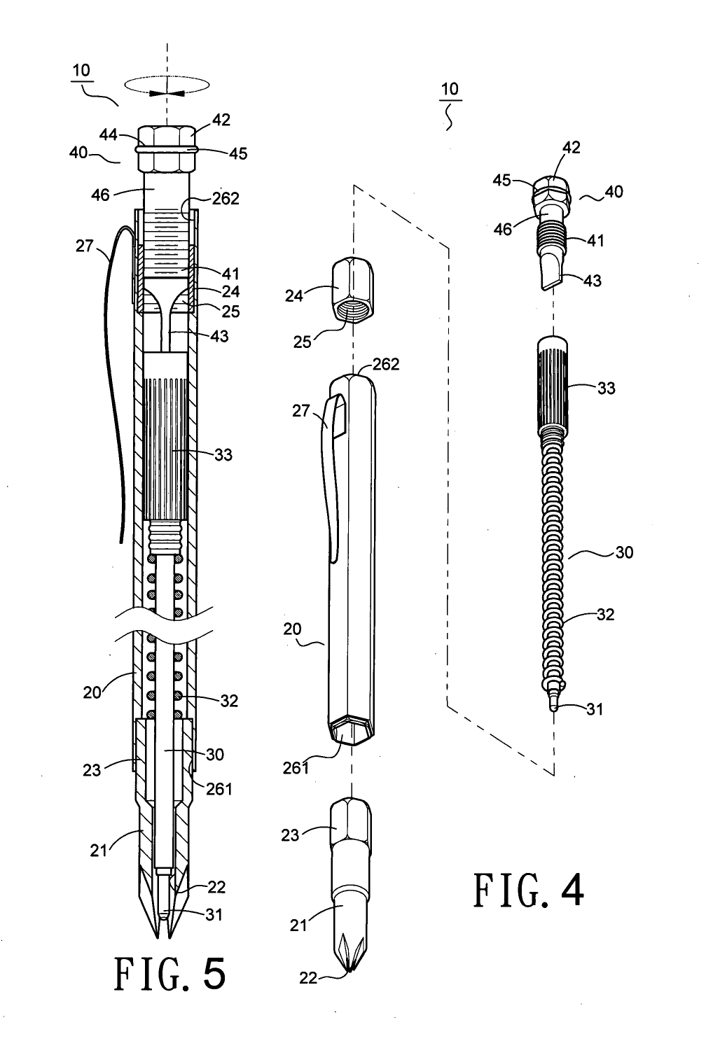

As shown in FIGS. 4˜6, a handy tool 10 of the second embodiment is different from the second embodiment as a distal end of the working end 21 installed with a polygonal ring 23, which can be inserted in a polygonal groove 261 at a proximal end of the hollow shaft 20. Furthermore, a distal end of the hollow shaft 20 has a polygonal groove 262 can receive a polygonal nut 24 embedded therein. While the fixed portion 40 has a screw bolt 41 can be screwed to an inner hole 25 of the nut 24 to and fro. The screw bolt 41 may be screwed to the nut 24 loosely or tightly, as outer threads formed on a lower end of the bolt is adapted to inner threads of the inner hole 25 to an extent that they are fastened together, but not being detached from betweens. Therefore, once the fixed portion 40 is rotated, a minimum distance between the screw bolt 41 and the nut 24 can be adjusted as desired.

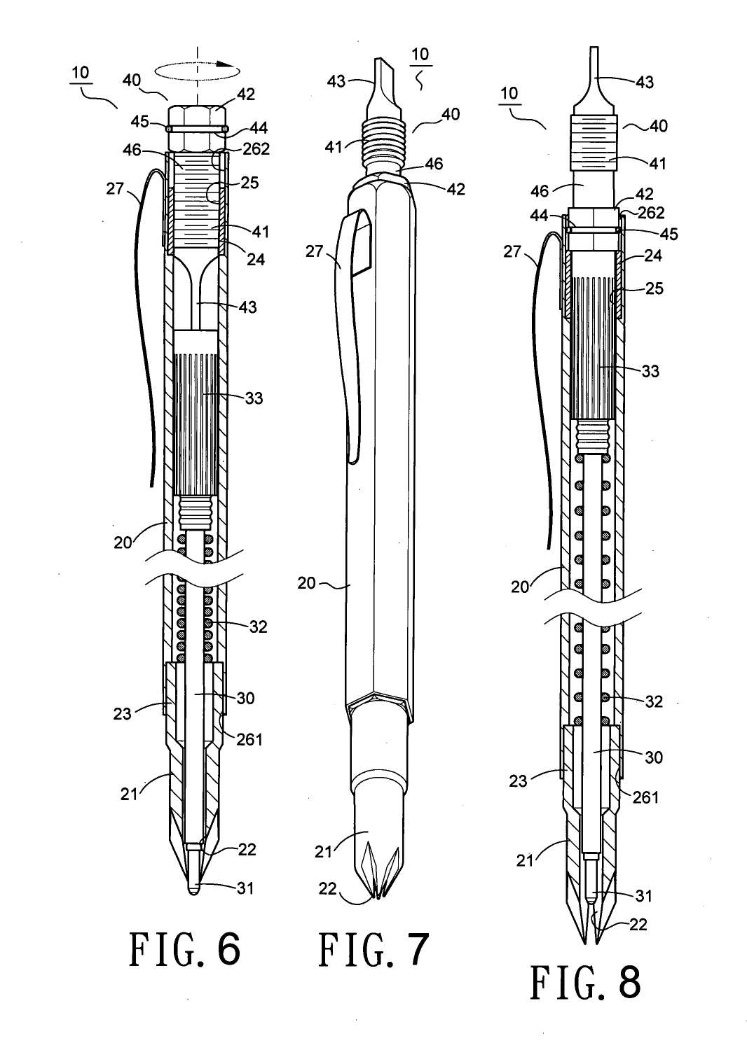

Furthermore, an expansion spring 32 fits around a circular cylindrical surface of the refills 31, a distal end of the refills 31 has a stopper 33 to resist against the expansion spring 32. As shown in FIG. 5, as the fixed portion 40 screwed to the nut 24 is loosened and elevated upward, the expansion spring 32 can urge the refills 30 to elevate upward, thereby the handwriting instrument 31 is retracted in the working end 21. As shown in FIG. 6, as the fixed portion 40 is tightened and descended downward, a proximal end of the fixed portion can urge the refills 30 to descend. The handwriting instrument 31 of the refills 30 is stretched out from the working end to facilitate handwriting function for customers.

As shown in FIGS. 7˜8, the fixed portion 40 has a screw bolt 41. A distal end of the screw bolt 41 is installed with a polygonal connector 42; a proximal end of the screw bolt 41 is equipped with a working end 43. The polygonal connector 42 can be inserted in the polygonal groove 262, where in a reverse direction opposite to the polygonal groove 262, the working end 43 is exposed outside the distal end of the polygonal connector 42 to be used as a handy tool. However, to facilitate the polygonal connector 42 secured to the polygonal groove 262, a shallow concave groove 44 can be formed along a circumference of the polygonal connector 42 for embedding an annular slip-proof rubber ring 45 in the groove 44. Thereby the polygonal connector 42 can fit in the polygonal groove 262 securely. The polygonal connector 42 fits in the polygonal groove 262 without any movements due to being combined together without any clearance between them.

In addition, if the polygonal connector 42 is exposed outside the hollow shaft 20, a center of palm in contact with the polygonal connector 42 makes it easier for the customers to apply with less fatigue on the customers' hands.

As mentioned above, the working end can be selected from one of the following: flat tip, philips tip, drill, awl, hexangular socket head nut. Obviously, except saw, knife, hammer, almost every kind of hand tool can be included.

### Third Embodiment

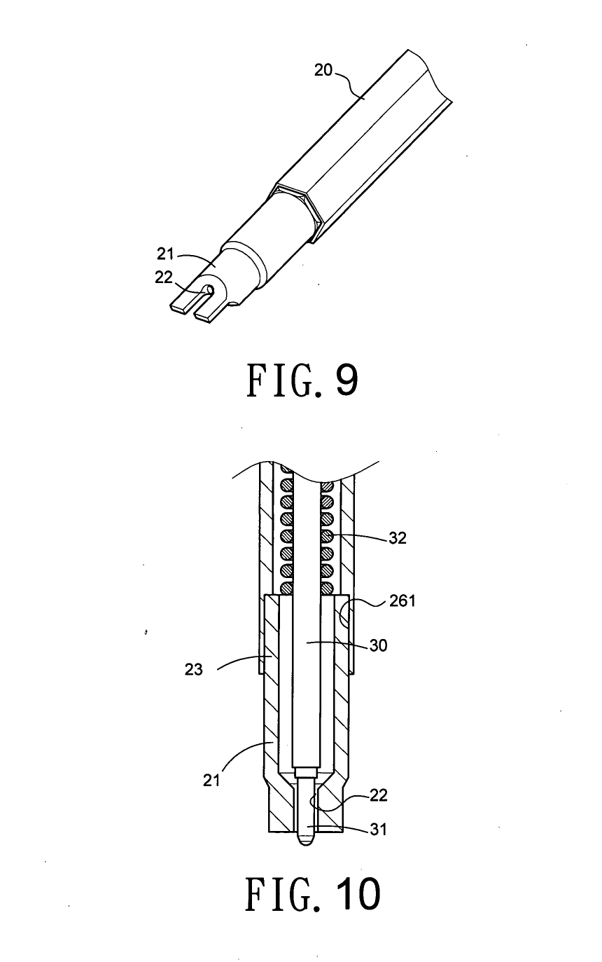

As shown in FIGS. 9˜10, a handy tool pen differs prior embodiments from a working end 21 is a flat tip. But a hole 21 is also axially formed through the working end 21, handwriting instrument 31 of the refills 30 can be stretched out or retracted in the working end 21. Also, the working end 21 can be formed as a hexangular socket head nut. (not shown).

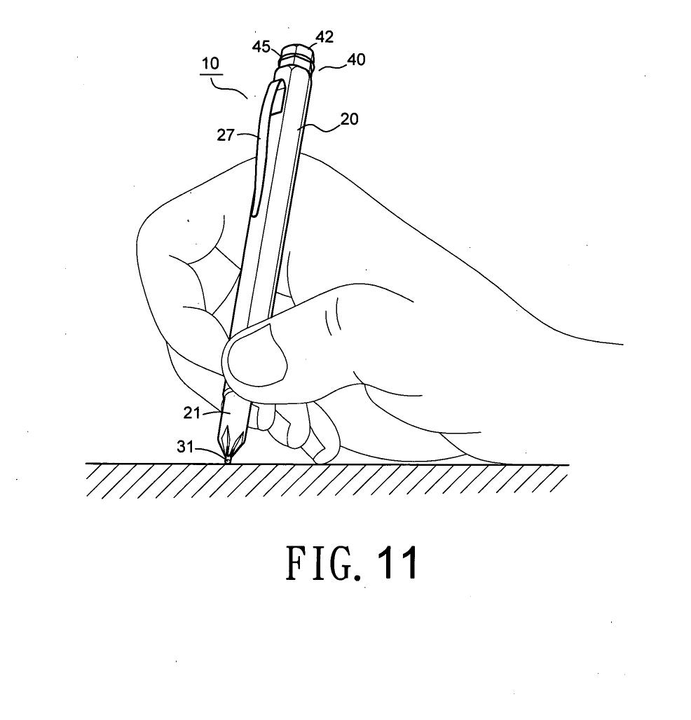

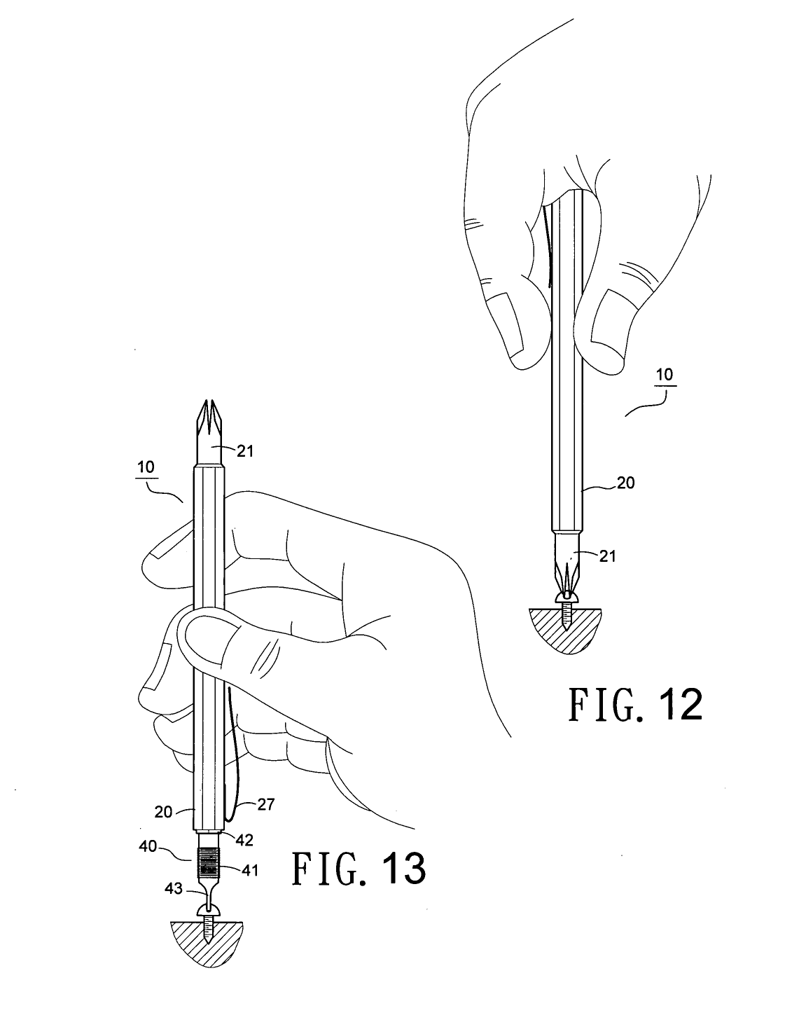

As shown in FIGS. 11˜13, schematic views of the handy tool pen in use are illustrated. The handy tool pen is not only to facilitate handwriting function for customers, but also a repair for office equipment. Furthermore, they are combined as a whole, either a handwriting instrument or a working end can be alternated in use promptly even without exchange laborious steps. Furthermore the cap can be provided to protect the working end in position, with a clip can clamp or hitch up on a pocket at ease.

### ADVANTAGES OF THE EMBODIMENTS OF THE INVENTION

Advantages can be achieved by embodiments of the invention as following:

A hole 22 axially formed through a center of the working end 21, on one hand, a handwriting instrument 31 fits through the hole 22 and exposed outside the working end 21 to facilitate a handwriting for a customers. On the other hand, as the refills 30 is taken out or retracted in the hollow shaft, the working end 21 restitutes as a screw driver to tighten or loosen a screw etc., it performed smoothly no matter in handwriting or working.

A distal end of the hollow shaft 20 is inset with a fixed portion 40, which can be adjusted at a minimum distance as the fixed portion 40 screwed to the distal end of the shaft 20 to and fro. A handwriting instrument 31 at a proximal end of the refills 30 fits through an expansion spring can be stretched out from or retracted in the working end 21, which can be alternated with the handwriting instrument 31 promptly to facilitate both handwriting and working performances selectively.

Fixed portion 40 at a distal end of the hollow shaft used as a working end, in turn, a distal end of the fixed portion is equipped with a flat/philips tip. When a flat/Philips tip is needed, in use, and inserted in the fixed portion 40 in a reverse direction relative to the handwriting instrument/working end at the proximal end of the hollow shaft. Thereby, both ends of the handy tool pen 10 can be equipped with working ends without any changes, especially, to the proximal end.

As the working end 43 at a distal end of the fixed portion 40 is inserted in a hollow shaft 20 in position, a proximal end of the fixed portion 40 has a polygonal connector 42 exposed outside of the hollow shaft 20. Thereby customers can exert force by a center of his palm in contact with the polygonal connector 42 at ease. Furthermore, the working end can be received inside a cap 50 safely, the cap 50 is further equipped with a clip to clamp onto a pocket.

What is claim claimed:

1. A handy tool pen (10) characterized in that: a proximal end of a hollow shaft (20) is equipped with a working end (21); a hole (22) is axially formed through the working end (21) at a center, a handwriting instrument (31) of a refills (30) can be alternatively stretched out from the hole (22), or retracted in the hole (22).

2. A handy tool pen (10) according to claim 1 wherein a polygonal ring (23) is installed to a distal end of the working end (21), the polygonal ring (23) fit in a polygonal groove (261) at a proximal end of the hollow shaft (20), a distal end of the hollow shaft (20) has a fixed portion (40) resists against a distal end of the refills (30).

3. A handy tool pen (10) according to claim 1 wherein a polygonal nut (24) embedded in a polygonal groove (262), which is at a distal end of the hollow shaft (20), the fixed portion (40) has a screw bolt (41) screwed to an inner hole (25) of the nut (24), whereby the screw bolt (41) can be adjusted to and fro.

4. A handy tool pen (10) according to claim 1 wherein an expansion spring (32) fit around a circular cylindrical surface of the refills (30), a distal end of the refills (30) has a stopper (33) to resist against the expansion spring (32).

5. A handy tool pen (10) according to claim 1 wherein a distal end of the screw bolt (41) of the fixed portion (40) has a polygonal connector (42), while a proximal end of the screw bolt (41) has a working end (43), the polygonal connector (42) fits in the polygonal groove (262).

5. A handy tool pen (10) according to claim 1 wherein a circumference of the polygonal connector (42) is formed with a shallow groove for embedding an annular rubber ring (45) therein.

6. A handy tool pen (10) according to claim 1 wherein the working end (21) can be selected from one of the following: philips tip, flat tip, hexangular socket head nut.

7. A handy tool pen (10) according to claim 1 wherein the working end (21) of the fixed portion (40) can be selected from one of the following: Philips tip, flat tip, hexangular socket head nut, drill head, awl.
